(19) United States
(12) Patent Application Publication
(10) Pub. No.: US 2009/0304119 A1
(43) Pub. Date: Dec. 10, 2009

(54) RECEIVING APPARATUS, RECEIVING METHOD AND WIRELESS COMMUNICATION SYSTEM

(76) Inventors: Shinichi KURODA, Tokyo (JP); Ryo Sawai, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/480,028

(22) Filed: Jun. 8, 2009

(30) Foreign Application Priority Data
Jun. 9, 2008 (JP) P2008-150915

(51) Int. Cl. H04L 27/06

(52) U.S. Cl. 375/340

(57) ABSTRACT

There is provided a receiving apparatus including a plurality of antennas, a power detection unit to detect received power of respective received signals received by the plurality of antennas, and a plurality of reception processing units that includes a first reception processing unit to perform reception processing with a first bit width on a received signal received by any one of the plurality of antennas and a second reception processing unit to perform reception processing with a second bit width smaller than the first bit width on a received signal detected by the power detection unit as having lower received power than the received signal to be processed by the first reception processing unit.

### BACKGROUND OF THE INVENTION

1. Field of the Invention

The present invention relates to a receiving apparatus, a receiving method and a wireless communication system.

2. Description of the Related Art

There is a recent tend to mount a plurality of transmitting-receiving antennas on a wireless communication apparatus in order to enable MIMO (Multiple-Input Multiple-Output) communications and diversity reception. Further, the wireless communication apparatus has structures for performing packet detection for each transmitting-receiving antenna, cutting out of packet frames and reception processing of cut-out packet frames.

The structure for performing reception processing of packet frames has a larger circuit scale than the other structures and it occupies as large as about 40% of the entire structure for packet reception in some cases. Further, reception processing of packet frames is generally performed with the same bit width regardless of which transmitting-receiving antenna has received the packet frame.

Japanese Unexamined Patent Publication No. 2001-339455 discloses a receiving apparatus that performs demodulation processing after selectively limiting the effective bit width of a signal received by one antenna in order to reduce the size and the power consumption of the apparatus.

### SUMMARY OF THE INVENTION

However, the characteristics of transmission lines under the actual environments are not always the same in the respective transmitting-receiving antennas. Accordingly, the received power of signals received by the respective transmitting-receiving antennas may be different. Therefore, in a wireless communication apparatus that performs reception processing of signals with the same bit width, there may be a case where reception processing is performed with an unnecessarily high bit width with respect to the received power of a signal received by a certain transmitting-receiving antenna. As a result, in the wireless communication apparatus that performs reception processing of signals with the same bit width, there is a concern that it consumes more power than necessary when receiving signals.

In light of the above concern, it is desirable to provide a novel and improved receiving apparatus, receiving method and wireless communication system that are capable of performing reception processing of signals received by a plurality of antennas with lower power consumption.

According to an embodiment of the present invention, there is provided a receiving apparatus that includes a plurality of antennas, a power detection unit to detect received power of respective received signals received by the plurality of antennas, and a plurality of reception processing units including a first reception processing unit to perform reception processing with a first bit width on a received signal received by any one of the plurality of antennas and a second reception processing unit to perform reception processing with a second bit width smaller than the first bit width on a received signal detected by the power detection unit as having lower received power than the received signal to be processed by the first reception processing unit.

The first bit width may be fixed in the first reception processing unit, and the second bit width may be fixed in the second reception processing unit, and the receiving apparatus may further include a selection unit to select a reception processing unit to perform reception processing of each received signal from the plurality of reception processing units based on the received power of the respective received signals detected by the power detection unit.

The receiving apparatus may further include a bit width limitation unit to limit a signal value of each received signal to a range of a compatible bit width of the reception processing unit selected by the selection unit, and the reception processing unit selected by the selection unit may perform reception processing of the received signal with a bit width limited by the bit width limitation unit.

The receiving apparatus may further include a bit width determination unit to dynamically set a compatible bit width of each of the plurality of reception processing units, and the bit width determination unit may set a larger bit width to a reception processing unit to perform reception processing of a received signal with higher received power detected by the power detection unit.

The reception processing may include at least one of Fourier transform processing, cutout processing of a frame as a processing unit of the Fourier transform and channel estimation processing.

According to another embodiment of the present invention, there is provided a receiving method that includes the steps of detecting received power of respective received signals received by a plurality of antennas, and performing reception processing with a first bit width on a received signal received by any one of the plurality of antennas and performing reception processing with a second bit width smaller than the first bit width on a received signal detected as having lower received power than the received signal to be processed with the first bit width.

According to another embodiment of the present invention, there is provided a wireless communication system which includes a receiving apparatus that includes a plurality of antennas, a power detection unit to detect received power of respective received signals received by the plurality of antennas, and a plurality of reception processing units including a first reception processing unit to perform reception processing with a first bit width on a received signal received by any one of the plurality of antennas and a second reception processing unit to perform reception processing with a second bit width smaller than the first bit width on a received signal detected by the power detection unit as having lower received power than the received signal to be processed by the first reception processing; and a transmitting apparatus being a transmission source of the received signals to be received by the plurality of antennas.

According to the embodiments of the present invention described above, it is possible to perform reception processing of signals received by a plurality of antennas with lower power consumption.

### BRIEF DESCRIPTION OF THE DRAWINGS

FIG. 1 is an explanatory view showing the overall structure of a wireless communication system according to an embodiment of the present invention.

FIG. 2 is an explanatory view showing the internal structure of a wireless communication apparatus related to the embodiment.

FIG. 3 is a functional block diagram showing the structure of a wireless communication apparatus according to a first embodiment of the present invention.

FIG. 4 is an explanatory view showing a specific example of processing by a selection/limitation unit 30.

FIG. 5 is an explanatory view showing a simulation result (SNR vs PER curve) of reception performance of the wireless communication apparatus according to the first embodiment of the present invention.

FIG. 6 is a flowchart showing the flow of the operation of the wireless communication apparatus according to the first embodiment of the present invention.

FIG. 7 is a functional block diagram showing the structure of a wireless communication apparatus according to a second embodiment of the present invention.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Preferred embodiments of the present invention will be described in the following order:

(1) Overall structure of the wireless communication system according to the embodiment

(2) Circumstances of development of the embodiment

(3) Wireless communication apparatus according to the first embodiment
(3-1) Structure of the wireless communication apparatus according to the first embodiment
(3-2) Operation of the wireless communication apparatus according to the first embodiment

(4) Wireless communication apparatus according to the second embodiment

(5) Summary

### (1) OVERALL STRUCTURE OF THE WIRELESS COMMUNICATION SYSTEM ACCORDING TO THE EMBODIMENT

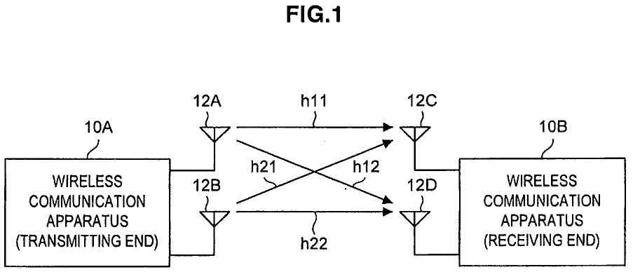

The overall structure of a wireless communication system 1 according to an embodiment of the present invention is described hereinafter with reference to FIG. 1.

FIG. 1 is an explanatory view showing the overall structure of the wireless communication system 1 according to the embodiment. As shown in FIG. 1, the wireless communication system 1 includes a plurality of wireless communication apparatus 10A and 10B. The wireless communication apparatus 10A and 10B may serve as any of the transmitting end and the receiving end, and FIG. 1 shows an example where the wireless communication apparatus 10A serves as the transmitting end and the wireless communication apparatus 10B (receiving apparatus) serves as the receiving end. When there is no particular need to distinguish between the wireless communication apparatus 10A and 10B, they are collectively referred to simply as the wireless communication apparatus 10.

As shown in FIG. 1, the wireless communication apparatus 10A includes a plurality of antennas 12A and 12B, and the wireless communication apparatus 10B includes a plurality of antennas 12C and 12D. The wireless communication apparatus 10A and 10B can implement diversity reception and MIMO communications based on IEEE 802.11n standard with use of the plurality of antennas 12A to 12D.

The diversity reception is a receiving method in which the wireless communication apparatus 10B receives radio signals transmitted from the periphery by the plurality of antennas 12C and 12D and uses the radio signals received by both antennas in a composite manner, thereby improving the reliability of communication even when the S/N ratio of the radio signals is low. The MIMO communication is a communication method in which the wireless communication apparatus 10A transmits signals from the antennas 12A and 12B, and the wireless communication apparatus 10B receives the signals by the antennas 12C and 12D and decrypts them. The MIMO communication is specifically described hereinafter.

It is assumed that a signal transmitted from the antenna 12A of the wireless communication apparatus 10A is x1, a signal transmitted from the antenna 12B of the wireless communication apparatus 10A is x2, a signal received by the antenna 12C of the wireless communication apparatus 10B is y1, and a signal received by the antenna 12D of the wireless communication apparatus 10B is y2. It is also assumed that the characteristics of a transmission line between the antenna 12A and the antenna 12C are h11, the characteristics of a transmission line between the antenna 12A and the antenna 12D are h12, the characteristics of a transmission line between the antenna 12B and the antenna 12C are h21 and the characteristics of a transmission line between the antenna 12B and the antenna 12D are h22. In this case, the relationship between a signal transmitted from the wireless communication apparatus 10A and a signal received by the wireless communication apparatus 10B can be represented as the following expression 1:

$$… ( \begin{matrix}y 1 \\ y 2\end{matrix} ) = ( \begin{matrix}h 11 & h 21 \\ h 12 & h 22\end{matrix} ) ( \begin{matrix}x 1 \\ x 2\end{matrix} ) \qquad ( Expression 1 )$$

The first term on the right-hand side of the expression 1 is sometimes called a channel matrix H (transfer function). The channel matrix H can be obtained in the wireless communication apparatus 10A by transmitting a known signal from the wireless communication apparatus 10B before transmission of x1 and x2.

The wireless communication apparatus 10B can estimate the signal transmitted from the antenna 12A to be x1 and the signal transmitted from the antenna 12B to be x2 by using the inverse matrix of the channel matrix H. In this manner, the MIMO communication is effective in being able to increase a transmission rate in proportion to the number of antennas without enlarging the frequency band to use. Although FIG. 1 shows an example where the wireless communication apparatus 10A and 10B each include two antennas, the wireless communication apparatus 10A and 10B may include three or more antennas.

Further, the diagonal elements of the channel matrix H become noise upon signal separation (cross talk) and cause a decrease in stream SNR. In order to suppress the cross talk, beam forming (Eigenmode-SDM (Space Division Multiplexing)) is proposed, and such beam forming may be applied to the present invention.

Further, the wireless communication apparatus 10 may be an information processing apparatus such as a PC (Personal Computer), a home video processing device (e.g. a DVD recorder, a videocassette recorder etc.), a cellular phone, a PHS (Personal Handyphone System), a portable sound playback device, a portable video processing device, a PDA (Personal-Digital Assistants), a home game device, a portable game device or an electrical household appliance.

### (2) CIRCUMSTANCES OF DEVELOPMENT OF THE EMBODIMENT

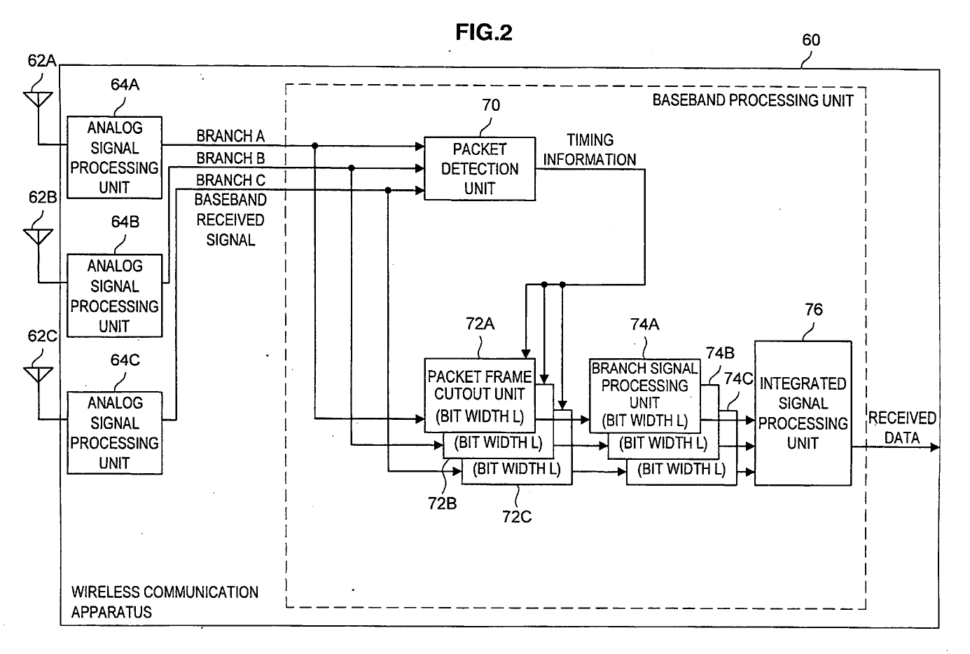

As described above, a wireless communication apparatus having a plurality of antennas in order to implement MIMO communication and diversity reception has been proposed recently. The internal structure of a wireless communication apparatus 60 having a plurality of antennas 62A to 62C, which is related to the embodiment, is described hereinafter with reference to FIG. 2.

FIG. 2 is an explanatory view showing the internal structure of the wireless communication apparatus 60 related to the embodiment. As shown in FIG. 2, the wireless communication apparatus 60 related to the embodiment includes a plurality of antennas 62A to 62C, a plurality of analog signal processing units 64A to 64C, a packet detection unit 70, a plurality of packet frame cutout units 72A to 72C, a plurality of branch signal processing units 74A to 74C, and an integrated signal processing unit 76.

The analog signal processing units 64A to 64C each include an ADC (Analog-to-Digital Conversion unit), receive radio signals received by the antennas 62A to 62C, respectively, convert the radio signals into digital baseband received signals and output the baseband received signals. The packet detection unit 70 performs packet detection from each baseband received signal using an auto-correlation circuit or the like and outputs timing information for packet frame cutout to the packet frame cutout units 72A to 72C.

The packet frame cutout units 72A to 72C cut out packets of the baseband received signals that are input from the analog signal processing units 64A to 64C, respectively, based on the timing information that is input from the packet detection unit 70, and output the cut-out packets to the branch signal processing units 74A to 74C in the subsequent stage. The branch signal processing units 74A to 74C perform signal processing on the packets that are cut out by the packet frame cutout units 72A to 72C with respect to each branch. The signal processing may include FFT (Fast Fourier Transform), channel estimation or the like, for example. The integrated signal processing unit 76 acquires received data from the signals processed by the branch signal processing units 74A to 74C using the inverse matrix of the channel matrix H, for example.

In the wireless communication apparatus 60 related to the embodiment, reception processing units such as the packet frame cutout units 72A to 72C and the branch signal processing units 74A to 74C are all compatible with the same bit width L.

However, the characteristics of transmission lines under the actual environments are not always the same in the respective antennas 62A to 62C. Accordingly, the received power of signals received by the respective antennas 62A to 62C may be different. Therefore, in the wireless communication apparatus 60 related to the embodiment that performs reception processing of the respective signals with the same bit width, there may be a case where reception processing is performed with an unnecessarily high bit width with respect to the received power of a signal received by a certain antenna 62. As a result, in the wireless communication apparatus 60 related to the embodiment, there are concerns that it consumes more power than necessary when receiving signals and that the circuit scale is not reducible.

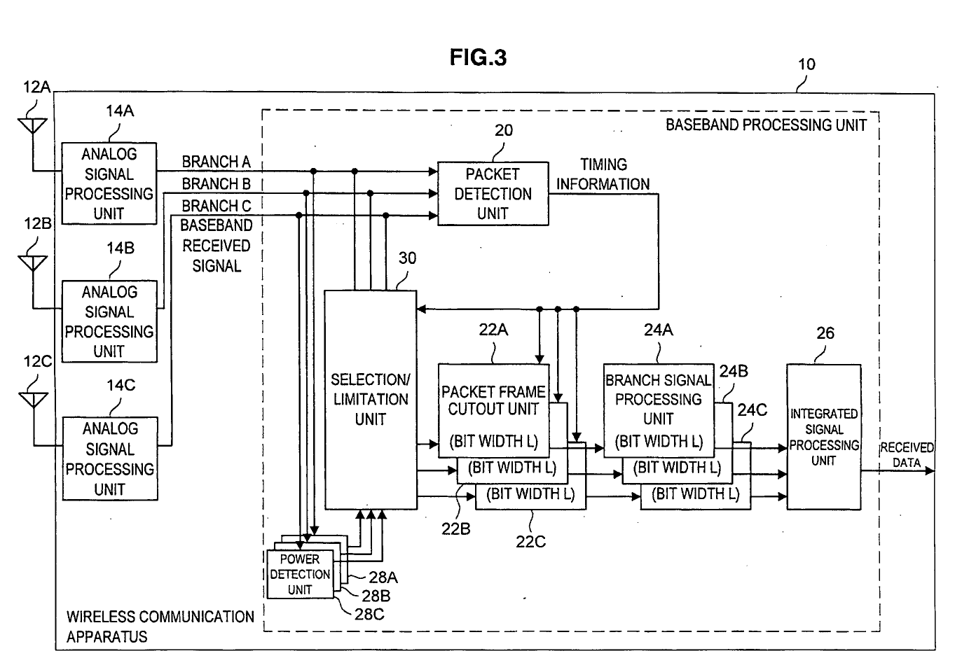

Given such circumstances, the wireless communication apparatus 10 according to the first embodiment of the present invention has been invented. According to the wireless communication apparatus 10 according to the first embodiment of the present invention, it is possible to reduce the circuit scale and perform reception processing of signals received by a plurality of antennas with lower power consumption. The wireless communication apparatus 10 is described hereinafter in detail with reference to FIGS. 3 to 6.

### (3) WIRELESS COMMUNICATION APPARATUS ACCORDING TO THE FIRST EMBODIMENT

### (3-1) Structure of the Wireless Communication Apparatus According to the First Embodiment

FIG. 3 is a functional block diagram showing the structure of the wireless communication apparatus 10 according to the first embodiment of the present invention. As shown in FIG. 3, the wireless communication apparatus 10 includes a plurality of antennas 12A to 12C, a plurality of analog signal processing units 14A to 14C, a packet detection unit 20, a plurality of packet frame cutout units 22A to 22C, a plurality of branch signal processing units 24A to 24C, an integrated signal processing unit 26, a plurality of power detection units 28A to 28C, and a selection/limitation unit 30.

Radio signals that are received by the antennas 12A to 12C are respectively input to the analog signal processing units 14A to 14C. The analog signal processing units 14A to 14C each include an ADC (Analog-to-Digital Conversion unit), and convert the input radio signals into digital baseband received signals and output the baseband received signals. For example, the analog signal processing unit 14A receives a radio signal received by the antenna 12A and performs down-conversion and digitization of the radio signal to thereby generate a digital baseband received signal and output it. A baseband received signal from the analog signal processing unit 14A is referred to also as a branch signal A, a baseband received signal from the analog signal processing unit 14B is referred to also as a branch signal B, and a baseband received signal from the analog signal processing unit 14C is referred to also as a branch signal C.

The packet detection unit 20 performs packet detection from each of the baseband received signals that are input from the analog signal processing units 14A to 14C and output of timing information for packet frame cutout to the packet frame cutout units 22A to 22C. For example, the packet detection unit 20 detects a short training field (STF) that is added at the head of the radio signal by an auto-correlation circuit. Further, the packet detection unit 20 detects the end of a preamble based on a long training field (LTF) that is added after the short training field and outputs the detected timing information to the packet frame cutout units 22A to 22C.

The packet frame cutout units 22A to 22C cut out packet frames of the baseband received signals that are selected by the selection/limitation unit 30 based on the timing information that is input from the packet detection unit 20, and output the cut-out packet frames to the branch signal processing units 24A to 24C, respectively.

The compatible bit width (word length) of each of the packet frame cutout units 22A to 22C is fixed, and the compatible bit width of at least any one of the packet frame cutout units 22A to 22C is different from the compatible bit width of the others. FIG. 3 shows an example where the compatible bit width of the packet frame cutout unit 22A is L, the compatible bit width of the packet frame cutout unit 22B is M, and the compatible bit width of the packet frame cutout unit 22C is N (L≧M≧N).

The branch signal processing units 24A to 24C receive the packet frames that are cut out by the packet frame cutout units 22A to 22C and perform signal processing on the packet frames. For example, the branch signal processing unit 24A receives the packet frame that is cut out by the packet frame cutout unit 22A and performs signal processing on the packet frame. The signal processing may include FFT (Fast Fourier Transform), channel estimation or the like, for example. Thus, the packet frame cutout units 22A to 22C and the branch signal processing units 24A to 24C function as reception processing units in cooperation with one another.

The compatible bit width of each of the branch signal processing units 24A to 24C is fixed, and the compatible bit width of at least any one of the branch signal processing units 24A to 24C is different from the compatible bit width of the others. FIG. 3 shows an example where the compatible bit width of the branch signal processing unit 24A is L, the compatible bit width of the branch signal processing unit 24B is M, and the compatible bit width of the branch signal processing unit 24C is N (L≧M≧N). FIG. 3 represents that the packet frame cutout unit 22 and the branch signal processing unit 24 with a larger compatible bit width have a larger circuit scale in a schematic manner by differentiating the size of each block.

The integrated signal processing unit 26 acquires received data from the signals processed by the branch signal processing units 24A to 24C using the inverse matrix of the channel matrix H, for example. The integrated signal processing unit 26 may appropriately correct the inverse matrix of the channel matrix H for use according to the condition of the transmission line.

The power detection units 28A to 28C detect and store the received power of the respective baseband received signals that are input from the analog signal processing units 14A to 14C. For example, the power detection unit 28A detects and stores the received power of the baseband received signal that is input from the analog signal processing unit 14A. Further, the power detection units 28A to 28C may detect and store an arbitrary parameter indicating the size of received power, such as the maximum value or the average value of the received power of the baseband received signals. Although the case where the power detection units 28A to 28C detect the received power of the baseband received signals that are input from the analog signal processing units 14A to 14C is illustrated in FIG. 3, the power detection units 28A to 28C may perform power detection in any position within the wireless communication apparatus 10.

The selection/limitation unit 30 selects the reception processing units to perform reception processing of the respective baseband received signals based on the received power of the respective baseband received signals detected by the power detection units 28A to 28C. Specifically, the selection/limitation unit 30 selectively connects each of the analog signal processing units 14A to 14C with any of the packet frame cutout units 22A to 22C.

More specifically, when the timing information is input from the packet detection unit 20, the selection/limitation unit 30 refers to the received power of the baseband received signals respectively detected by the power detection units 28A to 28C. Then, the selection/limitation unit 30 selects the structure with a larger compatible bit width as the received power is higher and selects the structure with a smaller compatible bit width as the received power is lower from the packet frame cutout units 22A to 22C and the branch signal processing units 24A to 24C.

In the example shown in FIG. 3, the selection/limitation unit 30 selects the packet frame cutout unit 22A and the branch signal processing unit 24A with the compatible bit width L (e.g. eleven bits) as the output destination of the baseband received signal having the highest received power. Further, the selection/limitation unit 30 selects the packet frame cutout unit 22C and the branch signal processing unit 24C with the compatible bit width N (e.g. nine bits) as the output destination of the baseband received signal having the lowest received power. Likewise, the selection/limitation unit 30 selects the packet frame cutout unit 22B and the branch signal processing unit 24B with the compatible bit width M (e.g. ten bits) as the output destination of the baseband received signal having the intermediate received power.

However, if the selection/limitation unit 30 outputs the baseband received signals to the packet frame cutout unit 22 and the branch signal processing unit 24 without modification, the signal value of the baseband received signals exceeds the processable range of the packet frame cutout unit 22 and the branch signal processing unit 24 in some cases. This may inhibit normal signal processing in the packet frame cutout unit 22 and the branch signal processing unit 24

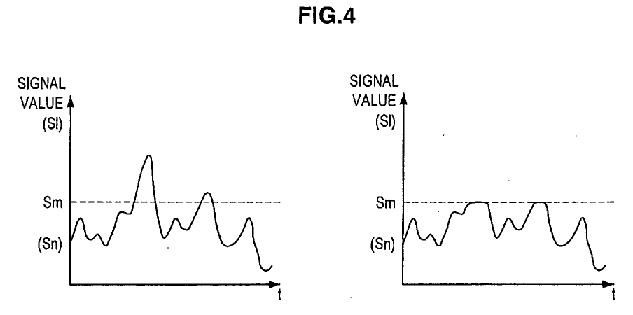

In light of this, the selection/limitation unit 30 limits the signal value of the respective baseband received signals to the processable range of the selected packet frame cutout unit 22 and the selected branch signal processing unit 24 and outputs the signals. A specific example of processing by the selection/limitation unit 30 is described hereinafter with reference to FIG. 4.

FIG. 4 is an explanatory view showing a specific example of processing by the selection/limitation unit 30. Specifically, the left part of FIG. 4 shows the signal value of the baseband received signal for which the packet frame cutout unit 22B and the branch signal processing unit 24B with the compatible bit width M (e.g. ten bits) are selected as the output destination. The signal value Sm is the upper limit of the signal value that can be processed in the packet frame cutout unit 22B and the branch signal processing unit 24B, which depends on the compatible bit width M. The signal value Sl in parentheses is the upper limit of the signal value that can be processed in the packet frame cutout unit 22A and the branch signal processing unit 24A, which depends on the compatible bit width L. Likewise, the signal value Sn in parentheses is the upper limit of the signal value that can be processed in the packet frame cutout unit 22C and the branch signal processing unit 24C, which depends on the compatible bit width N.

If the signal value of the baseband received signal is larger than the signal value Sm as shown in the left part of FIG. 4, the selection/limitation unit 30 limits the signal value of the baseband received signal to be equal to or smaller than the signal value Sm as shown in the right part of FIG. 4 and outputs it to the packet frame cutout unit 22B.

As described above, in the wireless communication apparatus 10 according to the first embodiment of the present invention, the compatible bit width of at least some of the packet frame cutout unit 22 and the branch signal processing unit 24 is reduced. It is thereby possible to reduce the circuit scale and the power consumption of the packet frame cutout unit 22 and the branch signal processing unit 24. The wireless communication apparatus 10 according to the first embodiment of the present invention additionally includes the power detection units 28A to 28C and the selection/limitation unit 30. However, the circuit scale of the power detection units 28A to 28C and the selection/limitation unit 30 is minor compared to the reduced size of the circuit scale of the packet frame cutout unit 22 and the branch signal processing unit 24.

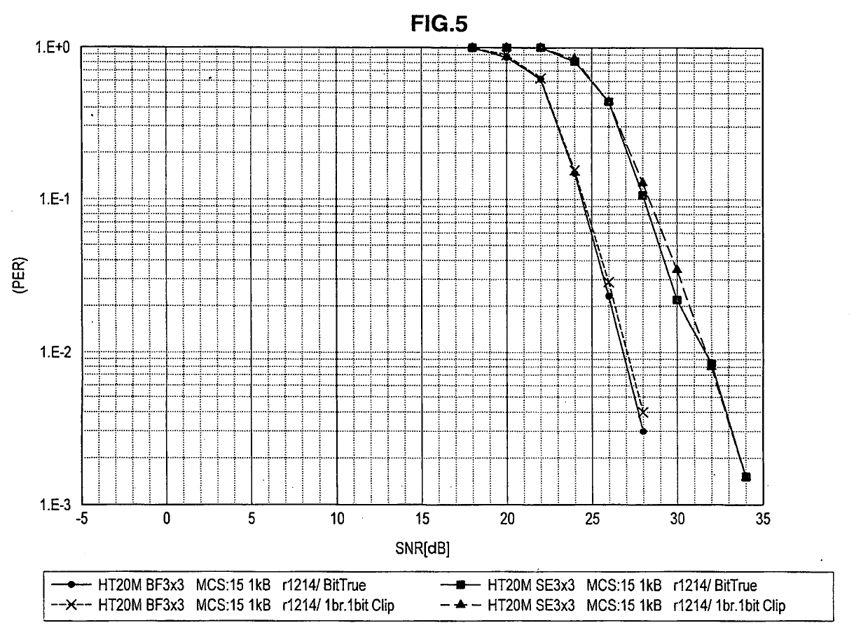

Further, the wireless communication apparatus 10 according to the first embodiment of the present invention can maintain sufficient reception performance in spite of reducing the compatible bit width of at least some of the packet frame cutout unit 22 and the branch signal processing unit 24. The reception performance of the wireless communication apparatus 10 according to the first embodiment of the present invention is described hereinafter with reference to FIG. 5.

FIG. 5 is an explanatory view showing a simulation result (SNR vs PER curve) of the reception performance of the wireless communication apparatus 10 according to the first embodiment of the present invention. Specifically, FIG. 5 shows a simulation result based on the following conditions.
The number of transmitting antennas and the number of receiving antennas: 3,3
The transmission line: 802.11n channel model+white noise
Packet format: 802.11n standard
   PPDU type: HT-mixed format PPDU
   PSDU length: 1000 bytes
   MCS: 15
   Signal bandwidth: 20 MHz
   Spatial mapper: spatial expansion and beamforming

In FIG. 5, the plot line with circle marks indicates the reception performance when the compatible bit widths of the reception processing units are the same and beam forming is executed. The plot line with square marks indicates the reception performance when the compatible bit widths of the reception processing units are the same the same and spatial expansion is executed. On the other hand, the plot lines with cross marks and triangle marks indicate the reception performance of the wireless communication apparatus 10 according to the embodiment. Specifically, the plot line with cross marks indicates the reception performance when beam forming is executed, and the plot line with triangle marks indicates the reception performance when spatial expansion is executed.

Referring to FIG. 5, although the reception performance of the wireless communication apparatus 10 according to the embodiment is slightly lower than the reception performance of the wireless communication apparatus 60 related to the embodiment, a difference in reception performance is considered to be within the range that causes no problem in actual use. Further, although the case where the wireless communication apparatus 10 includes three antennas 12 is described above, the advantage of applying the embodiment is more significant as the number of antennas 12 increases because the received power ratio among the baseband received signals is larger.

### (3-2) Operation of the Wireless Communication Apparatus According to the First Embodiment

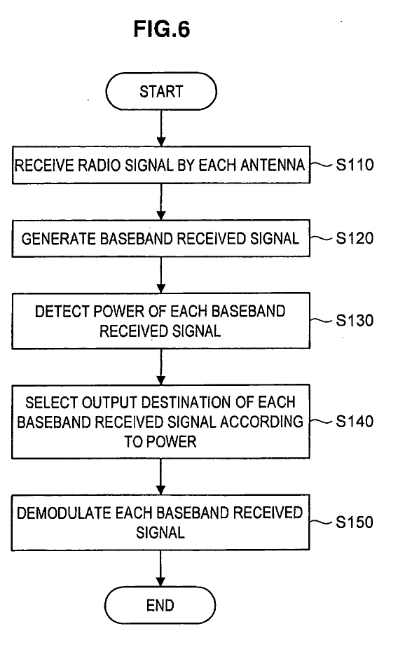

The structure of the wireless communication apparatus 10 according to the first embodiment of the present invention is described in the foregoing. Hereinafter, the operation of the wireless communication apparatus 10 according to the first embodiment of the present invention is described with reference to FIG. 6.

FIG. 6 is a flowchart showing the flow of the operation of the wireless communication apparatus 10 according to the first embodiment of the present invention. As shown in FIG. 6, the wireless communication apparatus 10 according to the embodiment first receive radio signals transmitted from the periphery by the plurality of antennas 12A to 12C (S110). Next, the analog signal processing units 14A to 14C convert the radio signals received by the antennas 12A to 12C into baseband received signals and output them (S120).

Then, the power detection units 28A to 28C detect and store the received power of the respective baseband received signals that are output from the analog signal processing units 14A to 14C (S130). Further, when the timing information is input from the packet detection unit 20, the selection/limitation unit 30 selects the reception processing units to perform reception processing of the respective baseband received signals based on the received power of the respective baseband received signals detected by the power detection units 28A to 28C (S140).

After that, any of the baseband received signals is input to the packet frame cutout units 22A to 22C and the branch signal processing units 24A to 24C based on the channel selection by the selection/limitation unit 30. Then, the packet frame cutout units 22A to 22C and the branch signal processing units 24A to 24C perform packet frame cutout processing, FFT processing or the like on the input baseband received signals, and then the integrated signal processing unit 26 performs demodulation processing (S150).

### (4) WIRELESS COMMUNICATION APPARATUS ACCORDING TO THE SECOND EMBODIMENT

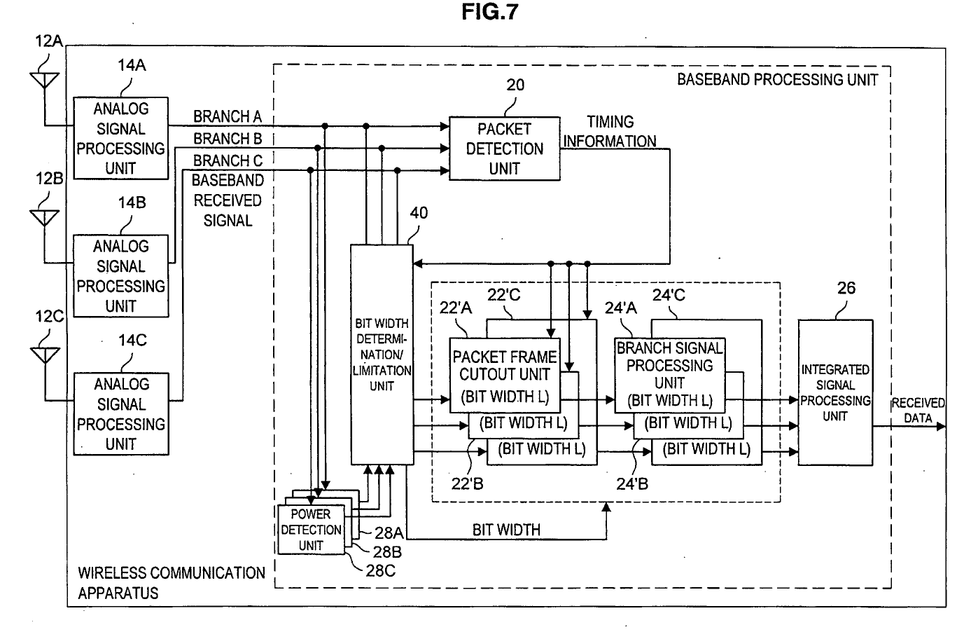

As described in the foregoing, in the wireless communication apparatus 10 according to the first embodiment of the present invention, each of baseband received signals is selectively processed by any of a plurality of reception processing units with a fixed compatible bit width according to received power. On the other hand, a wireless communication apparatus 10′ according to a second embodiment of the present invention is different from the wireless communication apparatus 10 according to the first embodiment in that the compatible bit width of each reception processing unit is variable. The wireless communication apparatus 10′ according to the second embodiment of the present invention is described hereinafter with reference to FIG. 7.

FIG. 7 is a functional block diagram showing the structure of the wireless communication apparatus 10′ according to the second embodiment of the present invention. As shown in FIG. 7, the wireless communication apparatus 10′ includes a plurality of antennas 12A to 12C, a plurality of analog signal processing units 14A to 14C, a packet detection unit 20, a plurality of packet frame cutout units 22′A to 22′C, a plurality of branch signal processing units 24′A to 24′C, an integrated signal processing unit 26, a plurality of power detection units 28A to 28C, and a bit width determination/limitation unit 40.

The structures of the plurality of antennas 12A to 12C, the plurality of analog signal processing units 14A to 14C, the integrated signal processing unit 26 and the plurality of power detection units 28A to 28C are described in the first embodiment and thus not repeatedly described below.

The packet frame cutout units 22′A to 22′C cut out packet frames of the respective baseband received signals based on the timing information that is input from the packet detection unit 20 and output the cut-out packet frames to the branch signal processing units 24′A to 24′C.

The compatible bit width of each of the packet frame cutout units 22′A to 22′C is variable, and the compatible bit width of each of the packet frame cutout units 22′A to 22′C is set by the bit width determination/limitation unit 40. FIG. 7 shows an example where the compatible bit width of the packet frame cutout unit 22′A is M, the compatible bit width of the packet frame cutout unit 22′B is N, and the compatible bit width of the packet frame cutout unit 22′C is L (L≧M≧N).

The branch signal processing units 24′A to 24′C receive the packet frames that are respectively cut out by the packet frame cutout units 22′A to 22′C, and perform signal processing on the packet frames. For example, the branch signal processing unit 24′A receives the packet frame that is cut out by the packet frame cutout unit 22′A and performs signal processing on the packet frame.

The compatible bit width of each of the branch signal processing units 24′A to 24′C is variable, and the compatible bit width of each of the branch signal processing units 24′A to 24′C is set by the bit width determination/limitation unit 40. FIG. 7 shows an example where the compatible bit width of the branch signal processing unit 24′A is M, the compatible bit width of the branch signal processing unit 24′B is N, and the compatible bit width of the branch signal processing unit 24′C is L (L≧M≧N).

The bit width determination/limitation unit 40 sets the compatible bit width of each of the packet frame cutout units 22′A to 22′C and the branch signal processing units 24′A to 24′C based on the received power of the respective baseband received signals detected by the power detection units 28A to 28C.

Specifically, when the timing information is input from the packet detection unit 20, the bit width determination/limitation unit 40 refers to the received power of the respective baseband received signals detected by the power detection units 28A to 28C. Then, the bit width determination/limitation unit 40 sets a larger bit width to the output destination of the baseband received signal with higher received power and sets a smaller bit width to the output destination of the baseband received signal with lower received power.

In the example shown in FIG. 7, the bit width determination/limitation unit 40 sets the bit width L (e.g. eleven bits) to the packet frame cutout unit 22′C and the branch signal processing unit 24′C, which are the output destinations of the baseband received signal with the highest received power. Further, the bit width determination/limitation unit 40 sets the bit width N (e.g. nine bits) to the packet frame cutout unit 22′B and the branch signal processing unit 24′B, which are the output destinations of the baseband received signal with the lowest received power. Likewise, the bit width determination/limitation unit 40 sets the bit width M (e.g. ten bits) to the packet frame cutout unit 22′A and the branch signal processing unit 24′A, which are the output destinations of the baseband received signal with the intermediate received power.

As described above, even if the output destination of each baseband received signal is fixed, it is possible to reduce the power consumption as in the first embodiment by dynamically setting the bit width that can be processed by each of the packet frame cutout unit 22′ and the branch signal processing unit 24′.

### (5) SUMMARY

As described in the foregoing, according to the first embodiment of the present invention, the compatible bit width of each of the packet frame cutout unit 22 and the branch signal processing unit 24 is fixed and not equal to each other. Further, when the timing information is input from the packet detection unit 20, the selection/limitation unit 30 refers to the received power of the respective baseband received signals detected by the power detection units 28A to 28C. Then, the selection/limitation unit 30 selects the structure with a larger compatible bit width as the received power is higher and selects the structure with a smaller compatible bit width as the received power is lower from the packet frame cutout units 22A to 22C and the branch signal processing units 24A to 24C. It is thereby possible to reduce the circuit scale and the power consumption of the reception processing units such as the packet frame cutout unit 22 and the branch signal processing unit 24 while suppressing degradation of the reception performance of the wireless communication apparatus 10.

Further, according to the second embodiment of the present invention, the bit width determination/limitation unit 40 dynamically sets the bit width of each of the packet frame cutout unit 22′ and the branch signal processing unit 24′ according to the received power of the respective baseband received signals. Consequently, it is possible to reduce the power consumption that occurs in the reception processing units such as the packet frame cutout unit 22′ and the branch signal processing unit 24′ in the second embodiment of the present invention just like the first embodiment.

It should be understood by those skilled in the art that various modifications, combinations, sub-combinations and alterations may occur depending on design requirements and other factors insofar as they are within the scope of the appended claims or the equivalents thereof.

For example, it is not necessary to perform each step in the processing of the wireless communication apparatus 10 in chronological order according to the sequence shown in the sequence chart or the flowchart. For example, and each step in the processing of the wireless communication apparatus 10 may include the processing which is performed in parallel or individually (e.g. parallel processing or object processing).

Furthermore, it is possible to create a computer program that causes hardware such as a CPU, ROM or RAM incorporated in the wireless communication apparatus 10 to perform the equal function to each structure of the wireless communication apparatus 10 described above. Further, a storage medium that stores such a computer program may be provided. Furthermore, each functional block shown in the functional block diagram of FIG. 3 and FIG. 7 may be implemented by hardware, thereby achieving a series of processing on hardware.

The present application contains subject matter related to that disclosed in Japanese. Priority Patent Application JP 2008-150915 filed in the Japan Patent Office on Jun. 9, 2008, the entire content of which is hereby incorporated by reference.

What is claimed is:

1. A receiving apparatus comprising:
a plurality of antennas;
a power detection unit to detect received power of respective received signals received by the plurality of antennas; and
a plurality of reception processing units including
a first reception processing unit to perform reception processing with a first bit width on a received signal received by any one of the plurality of antennas, and
a second reception processing unit to perform reception processing with a second bit width smaller than the first bit width on a received signal detected by the power detection unit as having lower received power than the received signal to be processed by the first reception processing unit.

2. The receiving apparatus according to claim 1, wherein
the first bit width is fixed in the first reception processing unit, and the second bit width is fixed in the second reception processing unit, and
the receiving apparatus further includes a selection unit to select a reception processing unit to perform reception processing of each received signal from the plurality of reception processing units based on the received power of the respective received signals detected by the power detection unit.

3. The receiving apparatus according to claim 2, further comprising:
a bit width limitation unit to limit a signal value of each received signal to a range of a compatible bit width of the reception processing unit selected by the selection unit, wherein
the reception processing unit selected by the selection unit performs reception processing of the received signal with a bit width limited by the bit width limitation unit.

4. The receiving apparatus according to claim 1, further comprising:
a bit width determination unit to dynamically set a compatible bit width of each of the plurality of reception processing units, wherein
the bit width determination unit sets a larger bit width to a reception processing unit to perform reception processing of a received signal with higher received power detected by the power detection unit.

5. The receiving apparatus according to one of claims 1 to 4, wherein
the reception processing includes at least one of Fourier transform processing, cutout processing of a frame as a processing unit of the Fourier transform and channel estimation processing.

6. A receiving method comprising the steps of:
detecting received power of respective received signals received by a plurality of antennas; and
performing reception processing with a first bit width on a received signal received by any one of the plurality of antennas, and performing reception processing with a second bit width smaller than the first bit width on a received signal detected as having lower received power than the received signal to be processed with the first bit width.

7. A wireless communication system comprising:
a receiving apparatus including:
a plurality of antennas,
a power detection unit to detect received power of respective received signals received by the plurality of antennas, and
a plurality of reception processing units including
a first reception processing unit to perform reception processing with a first bit width on a received signal received by any one of the plurality of antennas, and
a second reception processing unit to perform reception processing with a second bit width smaller than the first bit width on a received signal detected by the power detection unit as having lower received power than the received signal to be processed by the first reception processing; and
a transmitting apparatus being a transmission source of the received signals to be received by the plurality of antennas.
